(19) United States
(12) Patent Application Publication
(10) Pub. No.: US 2019/0291215 A1
(43) Pub. Date: Sep. 26, 2019

(54) MACHINING CONDITION ADJUSTMENT APPARATUS AND MACHINE LEARNING DEVICE

(71) Applicant: FANUC Corporation, Yamanashi (JP)

(72) Inventor: Takashi IZUMI, Yamanashi (JP)

(21) Appl. No.: 16/362,698

(22) Filed: Mar. 25, 2019

(30) Foreign Application Priority Data
Mar. 26, 2018 (JP) 2018-058280

(51) Int. Cl. B23K 31/00; B23K 26/70; B23K 26/36; G06N 20/00

(52) U.S. Cl. CPC B23K 31/006; G06N 20/00; B23K 26/36; B23K 26/705

(57) ABSTRACT

A machine learning device of a machining condition adjustment apparatus observes, as state variables expressing a current state of an environment, laser machining condition data in laser machining, and gas target deviation data indicating a target deviation of a pressure loss or a flow rate of assist gas. Then the machine learning device acquires determination data for determining quality of a workpiece machined on the basis of the laser machining condition, and learns the target deviation of the pressure loss or the flow rate of the assist gas and adjustment of the laser machining condition in the laser machining in association with each other using the determination data and the observed state variables.

### RELATED APPLICATIONS

The present application claims priority to Japanese Patent Application Number 2018-058280 filed Mar. 26, 2018, the disclosure of which is hereby incorporated by reference herein in its entirety.

### BACKGROUND OF THE INVENTION

### 1. Field of the Invention

The present invention relates to a machining condition adjustment apparatus and a machine learning device.

### 2. Description of the Related Art

Components (such as a machining head, a feed fiber, and a process fiber) of an external optical system configuring a laser machining apparatus that performs machining such as cutting of a workpiece with a laser beam are selected by a machine tool builder (MTB) (i.e., a machine tool manufacturer) that manufactures the laser machining apparatus. Therefore, a laser machining condition at the time of performing machining by the laser machining apparatus is required to be set for each MTB. However, since the operation of determining the machining condition becomes a large burden, it is likely that the machining condition is not sufficiently determined and the laser machining apparatus is shipped under a machining condition that is not optimum.

A laser machining condition at the time of performing machining by a laser machining apparatus is desirably a condition under which it is possible to perform machining at high speed while maintaining machining accuracy or machining quality at a certain level. As a conventional technology associated with the determination of a machining condition in laser machining described above, a technology for determining a laser machining condition using a machine learning device is disclosed in, for example, Japanese Patent Application Laid-open No. 2017-164801.

In order to evaluate a laser machining condition, it is necessary to evaluate machining accuracy, machining quality, or machining speed about machining performed under the machining condition and input its evaluation value to a machine learning device. Generally, machining speed may be automatically acquired as time required until machining is completed after its start. However, as for machining accuracy or machining quality such as finish of a machined surface, a measurement apparatus or the like for evaluating quality is required to be separately provided, or information is required to be manually input by a skilled operator through the visual observation and evaluation of the quality. As a result, the determination of a machining condition in laser machining becomes costly.

### SUMMARY OF THE INVENTION

In view of the above problem, the present invention has an object of providing a machining condition adjustment apparatus and a machine learning device capable of efficiently adjusting the laser machining condition of a laser machining apparatus.

The machining condition adjustment apparatus according to the present invention detects the machining quality of laser machining with a pressure loss or a flow rate of assist gas jetted onto a machined portion of a workpiece. On the machined portion of the workpiece, a kerf having a prescribed width is formed by the laser machining. However, when the assist gas is jetted onto the machined portion like this, the pressure loss or the flow rate of the assist gas changes with a kerf width, surface quality (machined surface quality) inside the kerf, a dross state, or the like. Therefore, the machining condition adjustment apparatus according to the present invention performs machining on a workpiece with a laser machining apparatus adjusted to be optimum in advance and causes a nozzle to adhere closely to or get close to the workpiece that has been machined into an optimum state as shown in FIG. 7. Then, in this state, the machining condition adjustment apparatus performs the machining quality detection operation of making the nozzle stationary on the kerf machined by jetting the assist gas with prescribed pressure instead of outputting a laser beam or moving the nozzle along the kerf and detecting a pressure loss or a flow rate of the assist gas with a sensor such as a pressure gauge. After that, the machining condition adjustment apparatus records the pressure loss or the flow rate of the assist gas calculated on the basis of a value detected by the machining quality detection operation as a target value.

Then, when performing the adjustment of the laser machining condition of a new laser machining apparatus, the machining condition adjustment apparatus tentatively machines a workpiece while adjusting the laser machining condition and then performs the same machining quality detection operation on a tentatively-machined portion of the workpiece to search for a laser machining condition under which a pressure loss or a flow rate of assist gas is approximated to the target value. By repeatedly performing such an operation, it becomes possible to efficiently find out an optimum laser machining condition without separately providing a measurement apparatus or the like for detecting a kerf width, surface quality (machined surface quality) inside a kerf, a dross state, or the like in the new laser machining apparatus.

According to an aspect of the present invention, a machining condition adjustment apparatus adjusts a laser machining condition of a laser machining apparatus that performs laser machining on a workpiece. The machining condition adjustment apparatus includes a machine learning device that learns the laser machining condition in the laser machining. The machine learning device has a state observation section that observes, as state variables expressing a current state of an environment, machining condition data indicating the laser machining condition in the laser machining, and gas target deviation data indicating a target deviation of a pressure loss or a flow rate of assist gas, a determination data acquisition section that acquires workpiece quality determination data for determining quality of the workpiece machined on the basis of the laser machining condition in the laser machining, as determination data indicating a propriety determination result of the machining of the workpiece, and a learning section that learns the target deviation of the pressure loss or the flow rate of the assist gas and adjustment of the laser machining condition in the laser machining in association with each other using the state variables and the determination data.

The determination data acquisition section may further acquire cycle time determination data for determining time taken for machining the workpiece, as the determination data indicating the propriety determination result of the machining of the workpiece.

The learning section may have a reward calculation section that calculates a reward associated with the propriety determination result, and a value function update section that updates, using the reward, a function expressing a value of an action of adjusting the laser machining condition in the laser machining with respect to the pressure loss or the flow rate of the assist gas. The reward calculation section may give a higher reward as the quality of the workpiece is higher and the time taken for machining the workpiece is shorter.

The learning section may calculate the state variables and the determination data in a multilayer structure.

According to another aspect of the present invention, a machining condition adjustment apparatus adjusts a laser machining condition of a laser machining apparatus that performs laser machining on a workpiece. The machining condition adjustment apparatus includes a machine learning device that has learned the laser machining condition in the laser machining. The machine learning device has a state observation section that observes, as state variables expressing a current state of an environment, machining condition data indicating the laser machining condition in the laser machining, and gas target deviation data indicating a target deviation of a pressure loss or a flow rate of assist gas, a learning section that has learned the target deviation of the pressure loss or the flow rate of the assist gas and adjustment of the laser machining condition in the laser machining in association with each other, and a decision-making section that determines the adjustment of the laser machining condition in the laser machining on the basis of the state variables observed by the state observation section and a learning result of the learning section.

The machine learning device may exist in a cloud server.

According to another aspect of the present invention, a machine learning device learns a laser machining condition of a laser machining apparatus that performs laser machining on a workpiece. The machine learning device includes: a state observation section that observes, as state variables expressing a current state of an environment, machining condition data indicating the laser machining condition in the laser machining, and gas target deviation data indicating a target deviation of a pressure loss or a flow rate of assist gas; a determination data acquisition section that acquires workpiece quality determination data for determining quality of the workpiece machined on the basis of the laser machining condition in the laser machining, as determination data indicating a propriety determination result of the machining of the workpiece; and a learning section that learns the target deviation of the pressure loss or the flow rate of the assist gas and adjustment of the laser machining condition in the laser machining in association with each other using the state variables and the determination data.

According to another aspect of the present invention, a machine learning device has learned a laser machining condition of a laser machining apparatus that performs laser machining on a workpiece. The machine learning device includes: a state observation section that observes, as state variables expressing a current state of an environment, machining condition data indicating the laser machining condition in the laser machining, and gas target deviation data indicating a target deviation of a pressure loss or a flow rate of assist gas; a learning section that has learned the target deviation of the pressure loss or the flow rate of the assist gas and adjustment of the laser machining condition in the laser machining in association with each other; and a decision-making section that determines the adjustment of the laser machining condition in the laser machining on the basis of the state variables observed by the state observation section and a learning result of the learning section.

According to the present invention, it is possible to automatically perform the operation of determining a laser machining condition in a laser machining apparatus without incurring large cost.

### BRIEF DESCRIPTION OF THE DRAWINGS

FIG. 1 is a schematic hardware configuration diagram of a machining condition adjustment apparatus according to an embodiment;

FIG. 2 is a schematic functional block diagram of the machining condition adjustment apparatus according to the embodiment;

FIG. 3 is a schematic functional block diagram showing an embodiment of the machining condition adjustment apparatus;

FIG. 4 is a schematic flowchart showing an embodiment of a machine learning method;

FIG. 5A is a diagram for describing a neuron;

FIG. 5B is a diagram for describing a neural network;

FIG. 6 is a schematic functional block diagram showing an embodiment of a system in which a machining condition adjustment apparatus is incorporated; and

FIG. 7 is a diagram for describing a machining quality detection operation introduced into the present invention.

### DETAILED DESCRIPTION OF THE PREFERRED EMBODIMENTS

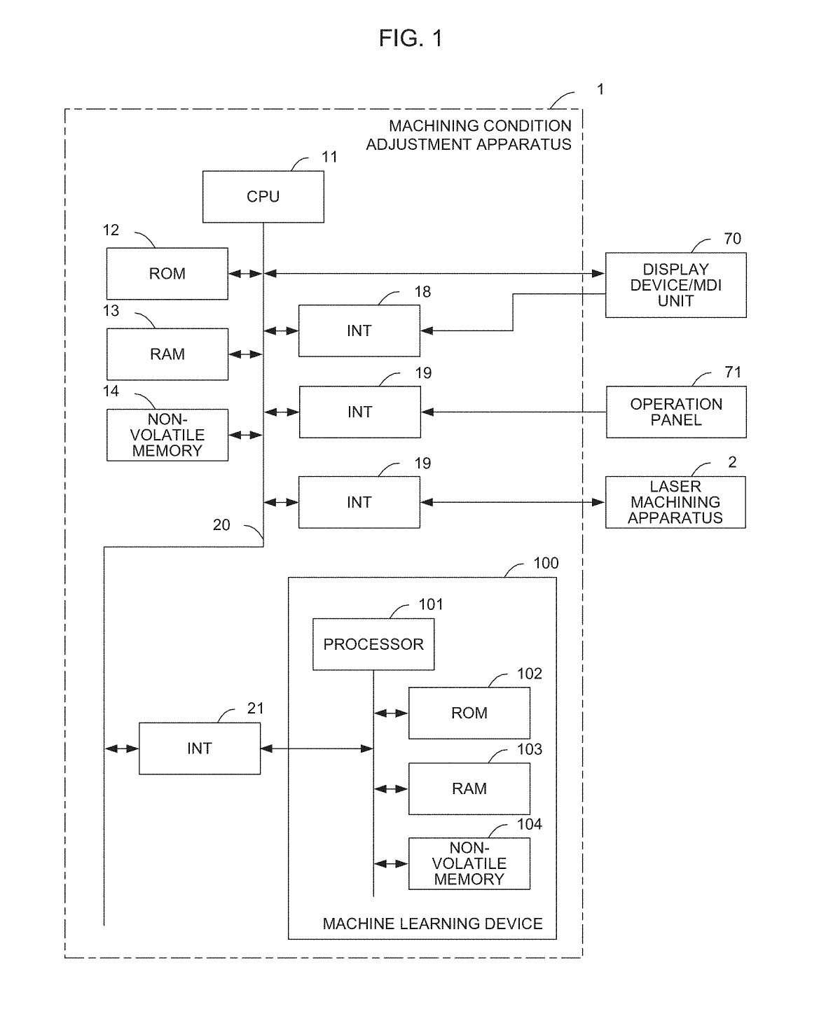

FIG. 1 is a schematic hardware configuration diagram showing the essential parts of a machining condition adjustment apparatus according to a first embodiment.

A machining condition adjustment apparatus 1 may be mounted as, for example, a controller that controls a laser machining apparatus. In addition, the machining condition adjustment apparatus 1 may be mounted as, for example, a personal computer installed next to a controller that controls a laser machining apparatus, a cell computer connected to a controller via a wired/wireless network, a host computer, or a computer such as an edge server and a cloud server. In the present embodiment, the machining condition adjustment apparatus 1 is mounted as a controller that controls a laser machining apparatus 2.

A central processing unit (CPU) 11 of the machining condition adjustment apparatus 1 according to the present embodiment is a processor that entirely controls the machining condition adjustment apparatus 1. The CPU 11 reads a system program stored in a read-only memory (ROM) 12 via a bus 20 and controls the entire machining condition adjustment apparatus 1 according to the system program. A random-access memory (RAM) 13 temporarily stores temporary calculation data or display data, various data input by an operator via an input unit not shown, or the like.

A non-volatile memory 14 is configured as a memory that maintains its storage state by, for example, data backup or the like with a battery (not shown) even if the power of the machining condition adjustment apparatus 1 is turned off. The non-volatile memory 14 stores a program input via a display device/MDI unit 70 and various data (such as, for example, a laser output, frequency, duty, machining speed, a type or pressure of assist gas, a nozzle diameter, a gap, a focal position, a pressure loss or a flow rate of assist gas detected by a sensor or the like attached to the laser machining apparatus 2, the relationships between these laser machining conditions and a machining position, or the like in laser machining by the laser machining apparatus 2) acquired from the respective units of the machining condition adjustment apparatus 1 or the laser machining apparatus 2. The program or the various data stored in the non-volatile memory 14 may be developed into the RAM 13 when run/used. In addition, the ROM 12 stores in advance various system programs such as known analysis programs (including a system program for controlling communication with a machine learning device 100 that will be described later).

The display device/MDI unit 70 is a manual data input unit including a display, a keyboard, or the like, and an interface 17 transfers command and data received from the keyboard of the display device/MDI unit 70 to the CPU 11. An interface 18 is connected to an operation panel 71 including a manual pulse generator used to manually drive respective axes or the like.

An interface 19 is an interface used to connect the machining condition adjustment apparatus 1 and the laser machining apparatus 2 to each other. An interface 21 is an interface used to connect the machining condition adjustment apparatus 1 and the machine learning device 100 to each other. The machine learning device 100 includes a processor 101 that controls the entire machine learning device 100, a ROM 102 that stores a system program or the like, a RAM 103 used to temporarily store data in respective processing associated with machine learning, and a non-volatile memory 104 used to store a learning model or the like. The machine learning device 100 may observe respective information (such as, for example, a laser output, frequency, duty, machining speed, a type or pressure of assist gas, a nozzle diameter, a gap, a focal position, a pressure loss or a flow rate of assist gas detected by a sensor or the like attached to the laser machining apparatus 2, the relationships between these laser machining conditions and a machining position, or the like in laser machining by the laser machining apparatus 2) capable of being acquired by the machining condition adjustment apparatus 1 via the interface 21. In addition, upon receiving a command for changing a machining condition output from the machine learning device 100, the machining condition adjustment apparatus 1 controls the operation of the laser machining apparatus 2.

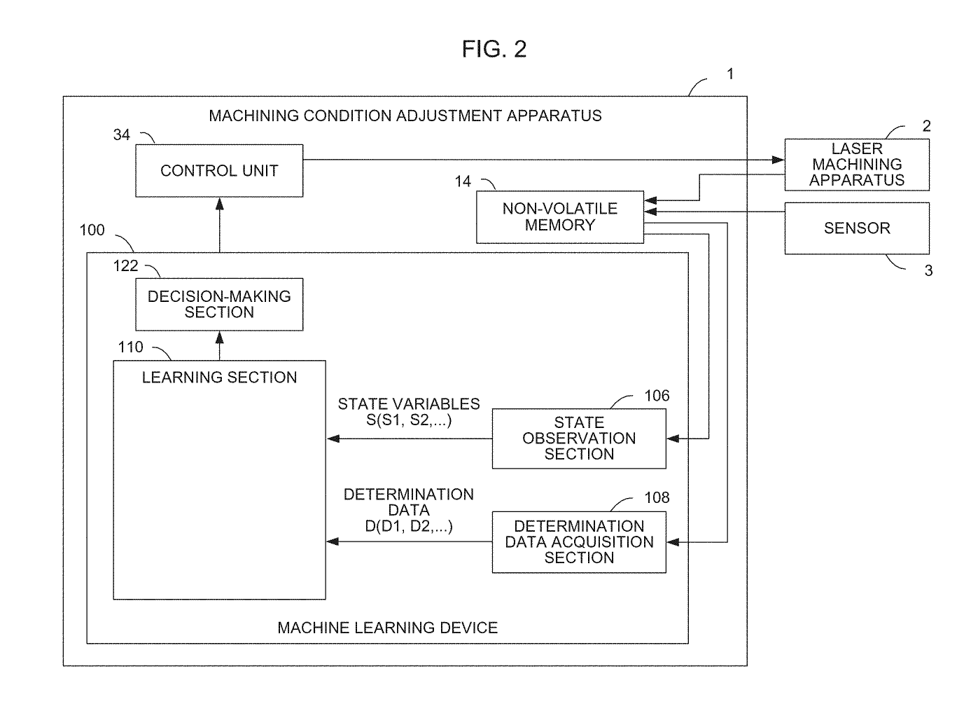

FIG. 2 is a schematic functional block diagram of the machining condition adjustment apparatus 1 and the machine learning device 100 according to an embodiment.

Respective functional blocks shown in FIG. 2 are realized when the CPU 11 of the machining condition adjustment apparatus 1 and the processor 101 of the machine learning device 100 shown in FIG. 1 perform their system programs and control the operations of the respective units of the machining condition adjustment apparatus 1 and the machine learning device 100.

The machining condition adjustment apparatus 1 according to the present embodiment includes a control unit 34 that controls the laser machining apparatus 2 on the basis of a command for changing a machining condition output from the machine learning device 100. A control unit 34 generally controls the operation of the laser machining apparatus 2 according to a command by a control program or the like. On this occasion, when receiving a command for changing a machining condition from the machine learning device 100, the control unit 34 controls the laser machining apparatus 2 such that a laser machining condition set in advance in the above program or the laser machining apparatus is replaced by a machining condition output from the machine learning device 100.

During the learning operation of the machine learning device 100, the control unit 34 performs the machining quality detection operation of detecting a pressure loss or a flow rate of the assist gas by means of a sensor 3 by making a nozzle stationary on a kerf machined by jetting assist gas with prescribed pressure instead of outputting a laser beam or by moving the nozzle along the kerf in a state in which the nozzle is caused to adhere closely to or get close to a workpiece after the workpiece is laser-machined by the laser machining apparatus 2 under an adjusted laser machining condition, and stores a pressure loss or a flow rate of the assist gas detected by a sensor 3 in the non-volatile memory 14 in association with a laser machining condition set when respective machined portions are machined. The machining quality detection operation may be performed in parallel during the machining. However, the state of a machined portion of a workpiece successively changes with time during the machining. Therefore, the machining quality detection operation is desirably performed after the machining since it is difficult to stably detect a pressure loss or a flow rate of assist gas (although it is also possible to perform a method for taking the average in a time axis or the like).

In the machining quality detection operation, a pressure loss or a flow rate may be recorded when assist gas is jetted with one prescribed pressure set in advance. Alternatively, with two or more levels of pressure set in advance, a plurality of pressure losses or flow rates may be recorded when assist gas is jetted with each of the pressure. In the latter case, with a target value of a pressure loss or a flow rate with each of the pressure recorded in advance, a laser machining condition may be adjusted such that each of a plurality of pressure losses or flow rates with corresponding pressure gets close to a target value. Depending on the state of a machined portion of a workpiece, a pressure loss or a flow rate is likely to change when assist gas is jetted under different pressure. Therefore, examination under a plurality of pressure makes it possible to perform the adjustment of a laser machining condition with higher accuracy compared with examination under one pressure.

On the other hand, the machine learning device 100 of the machining condition adjustment apparatus 1 includes software (such as a learning algorithm) and hardware (such as the processor 101) for spontaneously learning the adjustment of a laser machining condition in laser machining with respect to a target deviation of a pressure loss or a flow rate of assist gas through so-called machine learning. An object to be learned by the machine learning device 100 of the machining condition adjustment apparatus 1 corresponds to a model structure expressing the correlation between a target deviation of a pressure loss or a flow rate of assist gas and the adjustment of a laser machining condition in laser machining.

As shown in the functional blocks of FIG. 2, the machine learning device 100 of the machining condition adjustment apparatus 1 includes a state observation section 106, a determination data acquisition section 108, and a learning section 110. The state observation section 106 observes, as state variables S expressing the current state of an environment, laser machining condition data S1 indicating a laser machining condition in laser machining, and gas target deviation data S2 indicating a target deviation of a pressure loss or a flow rate of assist gas. The determination data acquisition section 108 acquires determination data D including workpiece quality determination data D1 for determining the quality of a workpiece machined on the basis of an adjusted laser machining condition in laser machining. The learning section 110 learns a target deviation of a pressure loss or a flow rate of assist gas and the adjustment of a laser machining condition in laser machining in association with each other using the state variables S and the determination data D.

Among the state variables S observed by the state observation section 106, the laser machining condition data S1 may be acquired as a laser machining condition in laser machining performed by the laser machining apparatus 2. The laser machining condition in laser machining includes, for example, a laser output, frequency, duty, machining speed, a type or pressure of assist gas, a nozzle diameter, a gap, a focal position, or the like in the laser machining by the laser machining apparatus 2. Particularly, the focal position and the machining speed have a large impact on finish in the laser machining. Therefore, at least these conditions are desirably included in the laser machining condition data S1. These laser machining conditions are set in a program for controlling the operation of the laser machining apparatus 2 or the machining condition adjustment apparatus 1 and may be acquired from laser machining parameters stored in the non-volatile memory 14 or the like.

As the laser machining condition data S1, the machine learning device 100 can directly use a laser machining condition in laser machining adjusted in the learning cycle with respect to a target deviation of a pressure loss or a flow rate of assist gas in the previous learning cycle on the basis of a learning result of the learning section 110. In such a case, the machine learning device 100 may temporarily store in advance a laser machining condition in laser machining in the RAM 103 for each learning cycle such that the state observation section 106 acquires from the RAM 103 a laser machining condition in laser machining in the previous learning cycle as the laser machining condition data S1 in the present learning cycle.

Among the state variables S observed by the state observation section 106, the gas target deviation data S2 may be acquired as a difference in a pressure loss or a flow rate of assist gas detected in the machining quality detection operation for a workpiece machined under an adjusted laser machining condition with respect to a target value of the pressure loss or the flow rate of the assist gas recorded on the non-volatile memory 14. Note that when a plurality of pressure losses or flow rates are recorded as target values, the gas target deviation data S2 may only be defined as a set (matrix) of differences in pressure losses or flow rates of assist gas under respective pressure.

When the learning section 110 performs learning on-line, the state observation section 106 may sequentially acquire respective state variables from the respective units of the laser machining apparatus 2, the sensor 3, and the machining condition adjustment apparatus 1. On the other hand, when the learning section 110 performs learning off-line, the machining condition adjustment apparatus 1 stores respective information acquired during the machining of a workpiece and a machining quality detection operation in the non-volatile memory 14 as log data. The state observation section 106 may only analyze the recorded log data to acquire respective state variables.

The determination data acquisition section 108 may use, as the workpiece quality determination data D1, a determination result of the quality of a workpiece when machining is performed on the basis of an adjusted laser machining condition in laser machining. As the workpiece quality determination data D1 used by the determination data acquisition section 108, data indicating whether a difference in a pressure loss or a flow rate of assist gas detected in the machining quality detection operation for a workpiece machined under an adjusted laser machining condition with respect to a target value of the pressure loss or the flow rate of the assist gas is smaller or larger than a prescribed threshold (appropriate or inappropriate) may be used.

Note that the determination data acquisition section 108 becomes a necessary configuration when the learning section 110 performs learning but does not become the necessary configuration after the learning section 110 completes learning in which a target deviation of a pressure loss or a flow rate of assist gas and the adjustment of a laser machining condition in laser machining are associated with each other. For example, when the machine learning device 100 that has completed learning is shipped to a customer, the determination data acquisition section 108 may be removed from the machine learning device 100 to be shipped.

In terms of the learning cycle of the learning section 110, the state variables S simultaneously input to the learning section 110 are those based on data in the previous learning cycle at which the determination data D has been acquired. As described above, while the machine learning device 100 of the machining condition adjustment apparatus 1 advances learning, the acquisition of the gas target deviation data S2, the machining of a workpiece by the laser machining apparatus 2 based on the laser machining condition data S1 adjusted on the basis of acquired respective data, and the acquisition of the determination data D are repeatedly performed in an environment.

The learning section 110 learns the adjustment of a laser machining condition in laser machining with respect to a target deviation of a pressure loss or a flow rate of assist gas according to any learning algorithm collectively called machine learning. The learning section 110 may repeatedly perform learning based on a data set including the state variables S and the determination data D described above. When the cycle of learning a laser machining condition in laser machining with respect to a target deviation of a pressure loss or a flow rate of assist gas is repeatedly performed, the state variables S are acquired from the target deviation of the pressure loss or the flow rate of the assist gas in the previous learning cycle and the laser machining condition in the laser machining adjusted in the previous learning cycle as described above. In addition, the determination data D corresponds to a propriety determination result of the machining of a workpiece performed on the basis of an adjusted laser machining condition in laser machining.

By repeatedly performing such a learning cycle, the learning section 110 is allowed to identify a feature suggesting the correlation between a target deviation of a pressure loss or a flow rate of assist gas and the adjustment of a laser machining condition in laser machining. Although the correlation between a target deviation of a pressure loss or a flow rate of assist gas and the adjustment of a laser machining condition in laser machining is substantially unknown at the start of a learning algorithm, the learning section 110 gradually identifies a feature and interprets the correlation as learning is advanced. When the correlation between a target deviation of a pressure loss or a flow rate of assist gas and the adjustment of a laser machining condition in laser machining is interpreted to a certain reliable extent, a learning result repeatedly output by the learning section 110 may be used to select the action (that is, decision making) of determining how the laser machining condition in the laser machining is adjusted with respect to a current state (that is, the target deviation of the pressure loss or the flow rate of the assist gas). That is, as a learning algorithm is advanced, the learning section 110 may gradually approximate the correlation between a target deviation of a pressure loss or a flow rate of assist gas and the action of determining how a laser machining condition in laser machining is adjusted to an optimum solution.

A decision-making section 122 adjusts a laser machining condition in laser machining on the basis of a learning result of the learning section 110 and outputs the adjusted laser machining condition in the laser machining to the control unit 34. The decision-making section 122 outputs a laser machining condition (such as a focal position, a nozzle diameter, and machining speed) in laser machining when a target deviation of a pressure loss or a flow rate of assist gas is input to the machine learning device 100 at a stage at which learning by the learning section 110 becomes available for adjusting the laser machining condition. The decision-making section 122 appropriately determines a laser machining condition in laser machining on the basis of the state variables S and a learning result of the learning section 110.

As described above, in the machine learning device 100 of the machining condition adjustment apparatus 1, the learning section 110 learns the adjustment of a laser machining condition in laser machining with respect to a target deviation of a pressure loss or a flow rate of assist gas according to a machine learning algorithm using the state variables S observed by the state observation section 106 and the determination data D acquired by the determination data acquisition section 108. The state variables S are composed of data such as the laser machining condition data S1 and the gas target deviation data S2. In addition, the determination data D is uniquely calculated from information acquired when a workpiece is machined or information acquired in the machining quality detection operation. Accordingly, by using a learning result of the learning section 110, the machine learning device 100 of the machining condition adjustment apparatus 1 makes it possible to automatically and accurately perform the adjustment of a laser machining condition in laser machining according to a target deviation of a pressure loss or a flow rate of assist gas.

Where it is possible to automatically adjust a laser machining condition in laser machining, an appropriate value of the laser machining condition in the laser machining may be quickly adjusted only by understanding a target deviation (the gas target deviation data S2) of a pressure loss or a flow rate of assist gas. Accordingly, a laser machining condition in laser machining may be efficiently adjusted.

As a modified example of the machine learning device 100 of the machining condition adjustment apparatus 1, the determination data acquisition section 108 may use, as the determination data D, cycle time determination data D2 for determining time taken for machining a workpiece performed on the basis of an adjusted laser machining condition in laser machining, besides the workpiece quality determination data D1. As the cycle time determination data D2 used by the determination data acquisition section 108, a result determined on the basis of an appropriately-set determination criterion such as one indicating whether time taken for machining a workpiece performed on the basis of an adjusted laser machining condition in laser machining is shorter or longer than a prescribed threshold (appropriate or inappropriate) may be, for example, used. The use of the cycle time determination data D2 as the determination data D makes it possible to provide a laser machining condition under which target machining quality may be realized without extremely increasing time taken for machining a workpiece.

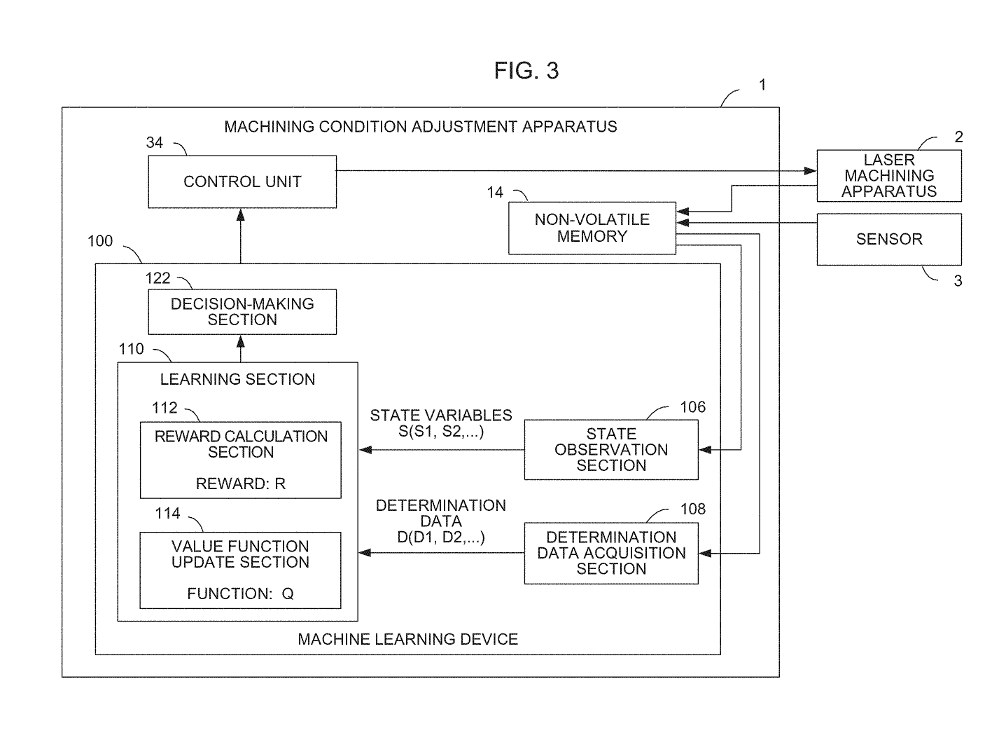

In the machine learning device 100 having the above configuration, a learning algorithm performed by the learning section 110 is not particularly limited. For example, a learning algorithm known as machine learning may be employed. FIG. 3 shows, as an embodiment of the machining condition adjustment apparatus 1 shown in FIG. 2, a configuration including the learning section 110 that performs reinforcement learning as an example of a learning algorithm. In the reinforcement learning, a cycle in which a current state (that is, an input) of an environment in which a learning target exists is observed and a prescribed action (that is, an output) is performed in the current state, and any reward is given to the action is repeatedly performed by trial and error to learn measures (a laser machining condition in the case of laser machining in the machine learning device of the present application) to maximize the total of the rewards as an optimum solution.

In the machine learning device 100 of the machining condition adjustment apparatus 1 shown in FIG. 3, the learning section 110 includes a reward calculation section 112 and a value function update section 114. The reward calculation section 112 calculates a reward R associated with a propriety determination result (corresponding to the determination data D used in the next learning cycle in which the state variables S have been acquired) of the machining of a workpiece by the laser machining apparatus 2 based on an adjusted laser machining condition in laser machining, the adjusted laser machining condition in the laser machining being obtained on the basis of the state variables S. The value function update section 114 updates, using the calculated reward R, a function Q expressing a value of a laser machining condition in laser machining. The learning section 110 learns the adjustment of a laser machining condition in laser machining with respect to a target deviation of a pressure loss or a flow rate of assist gas in such a way that the value function update section 114 repeatedly updates the function Q.

An example of a reinforcement learning algorithm performed by the learning section 110 will be described. The algorithm in this example is known as Q-learning and expresses a method in which a state s of an action subject and an action a capable of being taken by the action subject in the state s are assumed as independent variables and a function Q(s, a) expressing an action value when the action a is selected in the state s is learned. The selection of the action a by which the value function Q becomes the largest in the state s results in an optimum solution. By starting the Q-learning in a state in which the correlation between the state s and the action a is unknown and repeatedly performing the selection of various actions a by trial and error in any state s, the value function Q is repeatedly updated to be approximated to an optimum solution. Here, when an environment (that is, the state s) changes as the action a is selected in the state s, a reward (that is, weighting of the action a) r is obtained according to the change and the learning is directed to select an action a by which a higher reward r is obtained. Thus, the value function Q may be approximated to an optimum solution in a relatively short period of time.

Generally, the update formula of the value function Q may be expressed like the following Formula (1). In Formula (1), sₜ and aₜ express a state and an action at time t, respectively, and the state changes to sₜ₊₁ with the action aₜ. rₜ₊₁ expresses a reward obtained when the state changes from sₜ to sₜ₊₁. Q in the term of maxQ expresses a case in which an action a by which the maximum value Q is obtained at time t+1 (which is assumed at time t) is performed. α and γ express a learning coefficient and a discount rate, respectively, and arbitrarily set to fall within 0<α≤1 and 0≤γ≤1, respectively.

$$Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) \qquad ( 1 )$$

When the learning section 110 performs the Q-learning, the state variables S observed by the state observation section 106 and the determination data D acquired by the determination data acquisition section 108 correspond to the state s in the update formula, the action of determining how a laser machining condition in laser machining is adjusted with respect to a current state (that is, a target deviation of a pressure loss or a flow rate of assist gas) corresponds to the action a in the update formula, and the reward R calculated by the reward calculation section 112 corresponds to the reward r in the update formula. Accordingly, the value function update section 114 repeatedly updates the function Q expressing a value of a laser machining condition in laser machining with respect to a current state by the Q-learning using the reward R.

The reward R calculated by the reward calculation section 112 may be positive, for example, if a propriety determination result of the machining of a workpiece based on an adjusted laser machining condition in laser machining performed after the adjustment of the laser machining condition in the laser machining is determined to be “appropriate” (for example, a case in which a target deviation of a pressure loss or a flow rate of assist gas is a prescribed threshold or less, a case in which the cycle time of the machining of a workpiece is shorter than a prescribed threshold or a cycle time in the previous learning cycle, or the like) or may be negative, for example, if a propriety determination result of the operation of a workpiece based on an adjusted laser machining condition in laser machining performed after the adjustment of the laser machining condition in the laser machining is determined to be “inappropriate” (for example, a case in which a target deviation of a pressure loss or a flow rate of assist gas is more than a prescribed threshold, a case in which the cycle time of the machining of a workpiece is longer than a prescribed threshold or a cycle time in the previous learning cycle, or the like). The absolute values of the positive and negative rewards R may be the same or different from each other. In addition, as determination conditions, a plurality of values included in the determination data D may be combined together to perform a determination.

In addition, a propriety determination result of the machining of a workpiece based on an adjusted laser machining condition in laser machining may include not only “appropriate” and “inappropriate” results but also a plurality of levels of results. As an example, when the threshold of the cycle time of the machining of a workpiece is assumed as Tₘₐₓ, the reward R=5 is given if the cycle time T taken for performing laser machining on the workpiece falls within 0≤T<Tₘₐₓ/5, the reward R=3 is given if the cycle time T falls within Tₘₐₓ/5≤T<Tₘₐₓ/2, the reward R=1 is given if the cycle time T falls within Tₘₐₓ/2≤T<Tₘₐₓ, and the reward R=−3 (negative reward) is given if the cycle time T falls within Tₘₐₓ≤T.

In addition, when a plurality of determination data are used, a value of a reward is changed (weighted) for each of the determination data, whereby a target state in learning may be changed. For example, the adjustment of a laser machining condition that places importance on quality may be learned by increasing a given reward on the basis of a determination result of the workpiece quality determination data D1. On the other hand, the adjustment of a laser machining condition that places importance on speed may be learned by increasing a given reward on the basis of a determination result of the cycle time determination data D2. Moreover, a threshold used for a determination may be set to be relatively large at the initial stage of learning and set to be smaller as the leaning is advanced.

The value function update section 114 may have an action value table in which the state variables S, the determination data D, and the rewards R are organized in association with action values (for example, numeric values) expressed by the function Q. In this case, the action of updating the function Q with the value function update section 114 is equivalent to the action of updating the action value table with the value function update section 114. At the start of the Q-learning, the correlation between the current state of an environment and the adjustment of a laser machining condition in laser machining is unknown. Therefore, in the action value table, various kinds of the state variables S, the determination data D, and the rewards R are prepared in association with values (function Q) of randomly-set action values. Note that, when the determination data D is known, the reward calculation section 112 may immediately calculate the rewards R corresponding to the determination data D, and values of the calculated rewards R are written in the action value table.

When the Q-learning is advanced using the reward R corresponding to a propriety determination result of the operation of the laser machining apparatus 2, the learning is directed to select the action of obtaining a higher reward R. Then, values (function Q) of action values for an action performed in a current state are rewritten to update the action value table according to the state of an environment (that is, the state variables S and the determination data D) that changes as the selected action is performed in the current state. By repeatedly performing the update, values (the function Q) of action values displayed in the action value table are rewritten to be larger as an action is more appropriate (an action of adjusting a laser machining condition in laser machining such as increasing a focal distance, increasing or decreasing machining speed, urging the replacement of a nozzle, and increasing or decreasing the pressure of assist gas during machining without extremely increasing cycle time associated with the machining of a workpiece, in the case of the present invention). Thus, the correlation between a current state (a target deviation of a pressure loss or a flow rate of assist gas) in an unknown environment and a corresponding action (adjustment of a laser machining condition in laser machining) becomes gradually obvious. That is, by the update of the action value table, the relationship between a target deviation of a pressure loss or a flow rate of assist gas and the adjustment of a laser machining condition in laser machining is gradually approximated to an optimum solution.

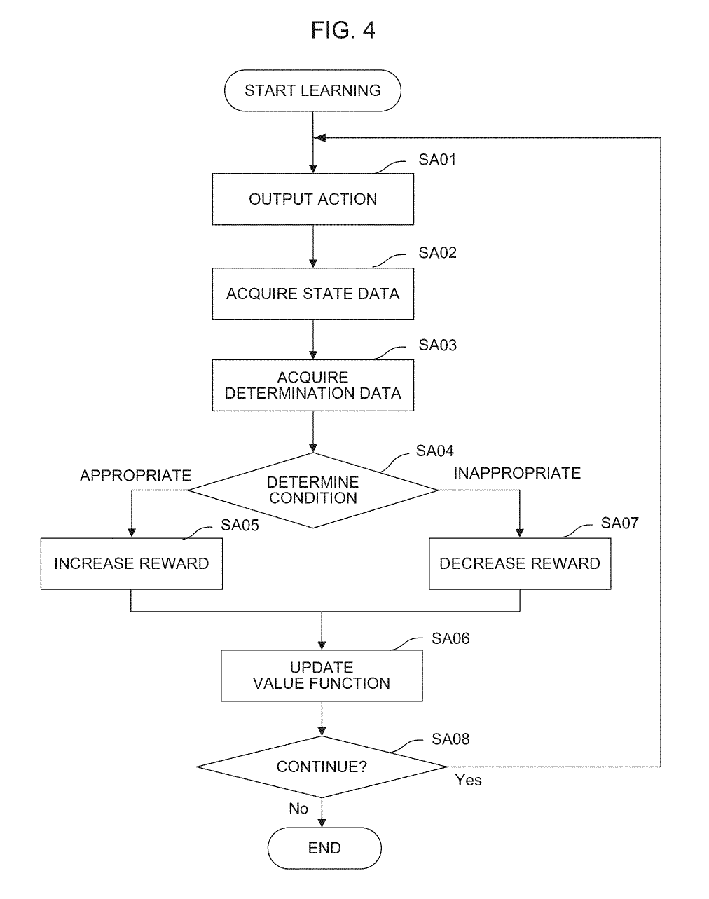

The flow of the above Q-learning (that is, an embodiment of a machine learning method) performed by the learning section 110 will be further described with reference to FIG. 4.

First, in step SA01, the value function update section 114 randomly selects, by referring to an action value table at that time, the action of adjusting a laser machining condition in laser machining as an action performed in a current state indicated by the state variables S observed by the state observation section 106. Next, the value function update section 114 imports the state variable S in the current state observed by the state observation section 106 in step SA02, and imports the determination data D in the current state acquired by the determination data acquisition section 108 in step SA03. Then, in step SA04, the value function update section 114 determines if the machining of a workpiece based on the adjusted laser machining condition in the laser machining has been appropriately performed on the basis of the determination data D. If the machining has been appropriately performed, the value function update section 114 applies a positive reward R calculated by the reward calculation section 112 to the update formula of the function Q in step SA05. Next, in step SA06, the value function update section 114 updates the action value table using the state variable S and the determination data D in the current state, the reward R, and a value (updated function Q) of an action value. If it is determined in step SA04 that the machining of the workpiece by the adjusted laser machining condition in the laser machining has been inappropriately performed, the value function update section 114 applies a negative reward R calculated by the reward calculation section 112 to the update formula of the function Q in step SA07. Then, in step SA06, the value function update section 114 updates the action value table using the state variable S and the determination data D in the current state, the reward R, and the value (updated function Q) of the action value. The learning section 110 updates the action value table over again by repeatedly performing the above processing of steps SA01 to SA07 and advances the learning of the adjustment of the laser machining condition in the laser machining. Note that the processing of calculating the rewards R and the processing of updating the value function in steps SA04 to SA07 are performed for each of data contained in the determination data D.

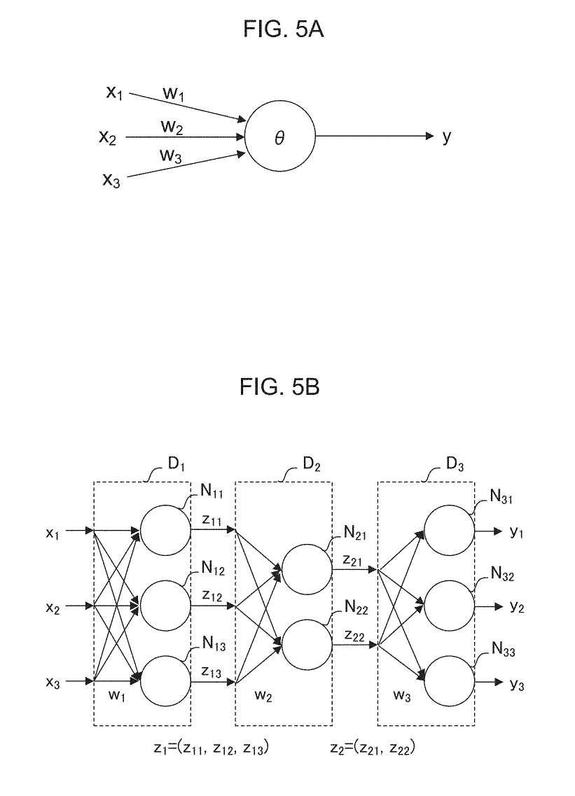

In advancing the above reinforcement learning, a neural network may be, for example, used. FIG. 5A schematically shows a neuron model. FIG. 5B schematically shows the model of a neural network having three layers in which the neurons shown in FIG. 5A are combined together. The neural network may be configured by, for example, a calculation unit, a storage unit, or the like following a neuron model.

The neuron shown in FIG. 5A outputs a result y with respect to a plurality of inputs x (here, inputs x₁ to x₃ as an example). The inputs x₁ to x₃ are multiplied by corresponding weights w (w₁ to w₃), respectively. Thus, the neuron outputs the result y expressed by the following Formula 2. Note that in the following Formula 2, an input x, a result y, and a weight w are all vectors. In addition, θ expresses a bias, and fₖ expresses an activation function.

y=fₖ(Σᵢ₌₁ⁿxᵢwᵢ−θ) (2)

In the neural network having the three layers shown in FIG. 5B, a plurality of inputs x (here, inputs x1 to x3 as an example) are input from the left side of the neural network, and results y (here, results y1 to y3 as an example) are output from the right side of the neural network. In the example shown in FIG. 5B, the inputs x1 to x3 are multiplied by corresponding weights (collectively expressed as w1) and input to three neurons N11 to N13, respectively.

In FIG. 5B, the respective outputs of the neurons N11 to N13 are collectively expressed as z1. The outputs z1 may be regarded as feature vectors obtained by extracting feature amounts of the input vectors. In the example shown in FIG. 5B, the respective feature vectors z1 are multiplied by corresponding weights (collectively expressed as w2) and input to two neurons N21 and N22, respectively. The feature vectors z1 express the features between the weights w1 and the weights w2.

In FIG. 5B, the respective outputs of neurons N21 and N22 are collectively expressed as z2. The outputs z2 may be regarded as feature vectors obtained by extracting feature amounts of the feature vectors z1. In the example shown in FIG. 5B, the respective feature vectors z2 are multiplied by corresponding weights (collectively expressed as w3) and input to three neurons N31 to N33, respectively. The feature vectors z2 express the features between the weights w2 and the weight w3. Finally, the neurons N31 to N33 output the results y1 to y3, respectively.

Note that it is possible to employ so-called deep learning in which a neural network forming three or more layers is used.

In the machine learning device 100 of the machining condition adjustment apparatus 1, the learning section 110 performs calculation in a multilayer structure according to the above neural network by using a neural network as a value function in the Q-learning and using the state variables S and the action a as the inputs x, whereby a value (result y) of the action in the state can be output. Note that the action mode of the neural network includes a learning mode and a value prediction mode. For example, it is possible to learn a weight w using a learning data set in the learning mode and make a value judgment of action by using the learned weight w in the value prediction mode. Note that detection, classification, deduction, or the like may be performed in the value prediction mode.

The configuration of the above machining condition adjustment apparatus 1 can be described as a machine learning method (or software) performed by the processor 101. The machine learning method is a method for learning the adjustment of a laser machining condition in laser machining.

In the machine learning method, the CPU of a computer performs:

a step of observing laser machining condition data S1 and gas target deviation data S2 as state variables S expressing the current state of an environment in which the laser machining apparatus 2 operates;

a step of acquiring determination data D indicating a propriety determination result of the machining of a workpiece based on an adjusted laser machining condition in laser machining; and

a step of learning the gas target deviation data S2 and the adjustment of the laser machining condition in the laser machining in association with each other using the state variables S and the determination data D.

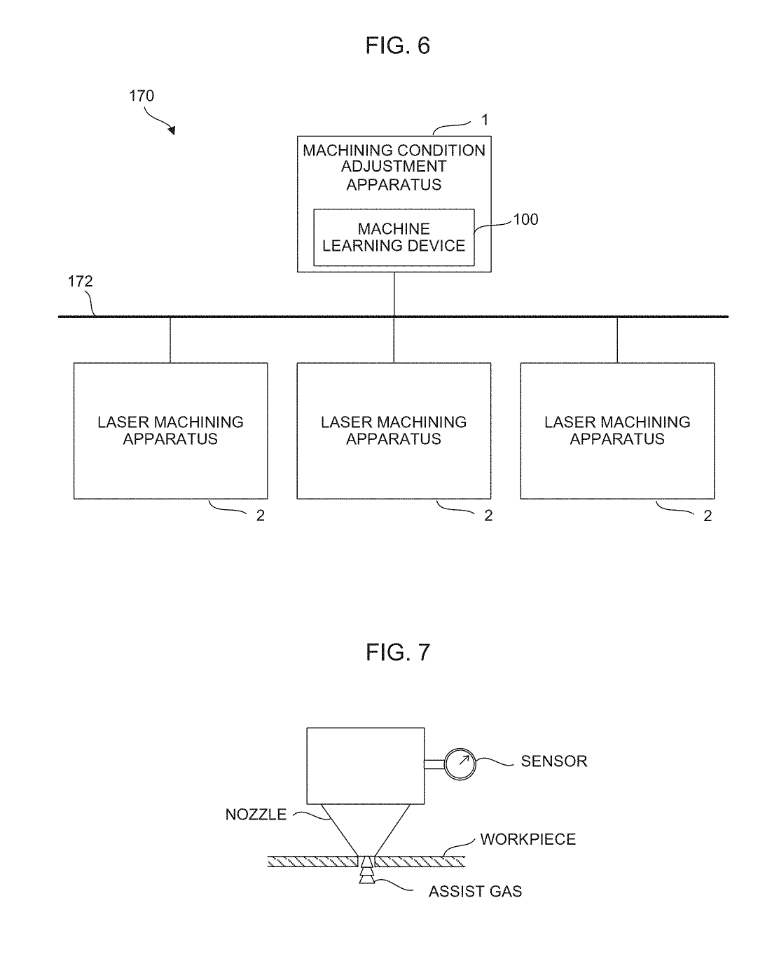

FIG. 6 shows a system 170 according to a third embodiment including a machining condition adjustment apparatus 1.

The system 170 includes at least one machining condition adjustment apparatus 1 mounted as a part of a computer such as a cell computer, a host computer, and a cloud server, a plurality of laser machining apparatuses 2 that are to be controlled, and a wired/wireless network 172 that connects the machining condition adjustment apparatus 1 and laser machining apparatuses 2 to each other.

In the system 170 having the above configuration, the machining condition adjustment apparatus 1 including a machine learning device 100 may automatically and accurately calculate the adjustment of a laser machining condition in laser machining with respect to a target deviation of a pressure loss or a flow rate of assist gas for each of the laser machining apparatuses 2 using a learning result of the learning section 110. In addition, the machine learning device 100 of the machining condition adjustment apparatus 1 may learn the adjustment of a laser machining condition in laser machining common to all the laser machining apparatuses 2 on the basis of state variables S and determination data D obtained for each of the plurality of laser machining apparatuses 2 and share a result of the learning in the operations of all the laser machining apparatuses 2.

Accordingly, the system 170 may improve the learning speed or reliability of the adjustment of a laser machining condition in laser machining using a variety of data sets (including state variables S and determination data D) as inputs.

The embodiments of the present invention are described above. However, the present invention is not limited to the examples of the above embodiments and may be carried out in various modes with the addition of appropriate modifications.

For example, a learning algorithm and a calculation algorithm performed by the machine learning device 100 and a control algorithm performed by the machining condition adjustment apparatus 1 are not limited to the above algorithms, but various algorithms may be employed.

In addition, the above embodiments describe a configuration in which the machining condition adjustment apparatus 1 and the machine learning device 100 have a different CPU. However, the machine learning device 100 may be realized by the CPU 11 of the machining condition adjustment apparatus 1 and a system program stored in the ROM 12.

1. A machining condition adjustment apparatus that adjusts a laser machining condition of a laser machining apparatus that performs laser machining on a workpiece, the machining condition adjustment apparatus comprising:
a machine learning device that learns the laser machining condition in the laser machining, wherein
the machine learning device has
a state observation section that observes, as state variables expressing a current state of an environment, machining condition data indicating the laser machining condition in the laser machining, and gas target deviation data indicating a target deviation of a pressure loss or a flow rate of assist gas,
a determination data acquisition section that acquires workpiece quality determination data for determining quality of the workpiece machined on the basis of the laser machining condition in the laser machining, as determination data indicating a propriety determination result of the machining of the workpiece, and
a learning section that learns the target deviation of the pressure loss or the flow rate of the assist gas and adjustment of the laser machining condition in the laser machining in association with each other using the state variables and the determination data.

2. The machining condition adjustment apparatus according to claim 1, wherein
the determination data acquisition section further acquires cycle time determination data for determining time taken for machining the workpiece, as the determination data indicating the propriety determination result of the machining of the workpiece.

3. The machining condition adjustment apparatus according to claim 1, wherein
the learning section has
a reward calculation section that calculates a reward associated with the propriety determination result, and
a value function update section that updates, using the reward, a function expressing a value of an action of adjusting the laser machining condition in the laser machining with respect to the pressure loss or the flow rate of the assist gas, and wherein
the reward calculation section gives a higher reward as the quality of the workpiece is higher and the time taken for machining the workpiece is shorter.

4. The machining condition adjustment apparatus according to claim 1, wherein
the learning section calculates the state variables and the determination data in a multilayer structure.

5. A machining condition adjustment apparatus that adjusts a laser machining condition of a laser machining apparatus that performs laser machining on a workpiece, the machining condition adjustment apparatus comprising:
a machine learning device that has learned the laser machining condition in the laser machining, wherein
the machine learning device has
a state observation section that observes, as state variables expressing a current state of an environment, machining condition data indicating the laser machining condition in the laser machining, and gas target deviation data indicating a target deviation of a pressure loss or a flow rate of assist gas,
a learning section that has learned the target deviation of the pressure loss or the flow rate of the assist gas and adjustment of the laser machining condition in the laser machining in association with each other, and
a decision-making section that determines the adjustment of the laser machining condition in the laser machining on the basis of the state variables observed by the state observation section and a learning result of the learning section.

6. The machining condition adjustment apparatus according to any one of claim 1, wherein
the machine learning device exists in a cloud server.

7. A machine learning device that learns a laser machining condition of a laser machining apparatus that performs laser machining on a workpiece, the machine learning device comprising:
a state observation section that observes, as state variables expressing a current state of an environment, machining condition data indicating the laser machining condition in the laser machining, and gas target deviation data indicating a target deviation of a pressure loss or a flow rate of assist gas;
a determination data acquisition section that acquires workpiece quality determination data for determining quality of the workpiece machined on the basis of the laser machining condition in the laser machining, as determination data indicating a propriety determination result of the machining of the workpiece; and
a learning section that learns the target deviation of the pressure loss or the flow rate of the assist gas and adjustment of the laser machining condition in the laser machining in association with each other using the state variables and the determination data.

8. A machine learning device that has learned a laser machining condition of a laser machining apparatus that performs laser machining on a workpiece, the machine learning device comprising:
a state observation section that observes, as state variables expressing a current state of an environment, machining condition data indicating the laser machining condition in the laser machining, and gas target deviation data indicating a target deviation of a pressure loss or a flow rate of assist gas;
a learning section that has learned the target deviation of the pressure loss or the flow rate of the assist gas and adjustment of the laser machining condition in the laser machining in association with each other; and
a decision-making section that determines the adjustment of the laser machining condition in the laser machining on the basis of the state variables observed by the state observation section and a learning result of the learning section.

9. The machining condition adjustment apparatus according to any one of claim 5, wherein
the machine learning device exists in a cloud server.
